(19) United States
(12) Patent Application Publication
(10) Pub. No.: US 2011/0295477 A1
(43) Pub. Date: Dec. 1, 2011

(54) DEVICE FOR PREVENTING SUDDEN ACCELERATION OF VEHICLE

(76) Inventors: CHUN-CHIH WANG, TAINAN (TW); MI-HAN LEE, KAOHSIUNG (TW)

(21) Appl. No.: 12/789,818

(22) Filed: May 28, 2010

(51) Int. Cl. G06F 19/00

(52) U.S. Cl. 701/70

(57) ABSTRACT

A device for preventing sudden acceleration of vehicles is revealed. The device includes a vehicle accelerator pedal that is electrically connected with an accelerator pedal sensor (APS), two load feedback signal lines of the APS that are electrically connected with an electronic control unit (ECU) of vehicles and a voltage control unit. The voltage control unit is electrically connected with the APS and is connected with the two load feedback signal lines of the APS in parallel for controlling voltage of the two signal lines. The voltage control unit is electrically connected with a switch unit. Thereby when the two load feedback signal lines operate abnormally and cause unintended acceleration, users turn on the switch unit directly for driving the voltage control unit to reduce the voltage of the two signal lines. Thus the ECU slows engine speed to idle speed so as to prevent the unintended acceleration.

### BACKGROUND OF THE INVENTION

1. Fields of the invention

The present invention relates to a device for preventing sudden acceleration of vehicles, especially to a device that reduces voltage of two load feedback signal lines of an accelerator pedal sensor (APS) for driving an electronic control unit (ECU) decreasing engine speed to idle speed when the two load feedback signal lines of the APS are under abnormal operating conditions so as to prevent sudden acceleration of vehicles.

2. Descriptions of Related Art

The automobile industry provides people great convenience and mobility in their lives. Along with the progress of modern technology, the development of automobile industry is enhanced. The release of electronic control unit (ECU) resolves problems caused by vehicles engines such as improper use of fuel and waste gas pollution.

Due to its powerful processing ability, the ECU provides more functions such as speed control etc. besides controlling the amount of fuel and gas input. The vehicles now include an accelerator pedal sensor (APS) assembled on an accelerator pedal and two load feedback signal lines of the APS are electrically connected with the ECU. When drivers press the accelerator, the APS detects the magnitude of the accelerator pressed by drivers and sends a corresponding voltage value to the ECU through the two load feedback signal lines. After getting the voltage value, the ECU outputs the amount of fuel and gas input corresponding to the voltage value so as to make the vehicle engine generate the required speed.

However, although the engine speed can be controlled precisely by the APS in combination with the ECU, the voltage value transmitted from the APS to the ECU by the two load feedback signal lines is under abnormal condition when the APS is out of order. Thus unexpected or unintended acceleration occurs when the car is parked or running at lower speed. This results in vehicles crashes and injuries to drivers and passengers or even death/injuries to people passing by.

The vehicles available now attain precise engine speed control by electronics such as APS and ECU. Yet the vehicles are also at risk of sudden acceleration if the electronics fail. Thus there is a need to provide a device for preventing sudden acceleration of vehicles.

### SUMMARY OF THE INVENTION

Therefore it is a primary object of the present invention to provide a device for preventing sudden acceleration of vehicles that reduces voltage of two load feedback signal lines of an accelerator pedal sensor (APS) immediately when the two load feedback signal lines of the APS are under abnormal operating conditions so as to avoid sudden acceleration of vehicles right away.

In order to achieve above object, a device for preventing sudden acceleration of vehicles according to the present invention includes an APS electrically connected with a vehicle accelerator pedal and two load feedback signal lines of the APS that are electrically connected with an electronic control unit (ECU). The present invention features on a voltage control unit.

The voltage control unit that is electrically connected with the APS and is connected with the two load feedback signal lines of the APS in parallel for control of the voltage of the two load feedback signal lines. Moreover, the voltage control unit is electrically connected with a switch unit.

Thereby when the two load feedback signal lines of the APS transmit abnormal signals to the vehicle ECU, lead to increasing of engine speed and result in sudden acceleration of the vehicle, users can operate the switch unit immediately so as to send signals for activating the voltage control unit. Thus the voltage control unit synchronously reduces the voltage of the two load feedback signal lines to a lower level. Then the two load feedback signal lines send a signal to the ECU after the voltage drop so as to make the ECU slow the engine speed into idle speed. Thus the sudden acceleration of vehicles is avoided right now. Therefore, the device is effective in preventing unintended acceleration.

The present invention further includes a power source and an active indicator light, arranged outside the voltage control unit. Thus users can learn that the voltage control unit is turned on and working well by the active indicator light and the safety in use is assured.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a perspective view of another embodiment according to the present invention;

FIG. 3 is a perspective view of a further embodiment according to the present invention;

FIG. 4 is a perspective view of a further embodiment according to the present invention;

FIG. 5 is a circuit block diagram of an embodiment according to the present invention;

FIG. 6 shows circuit diagrams of an embodiment according to the present invention.

FIG. 7 shows circuit diagrams of an embodiment according to the present invention.

### DETAILED DESCRIPTION OF THE PREFERRED EMBODIMENT

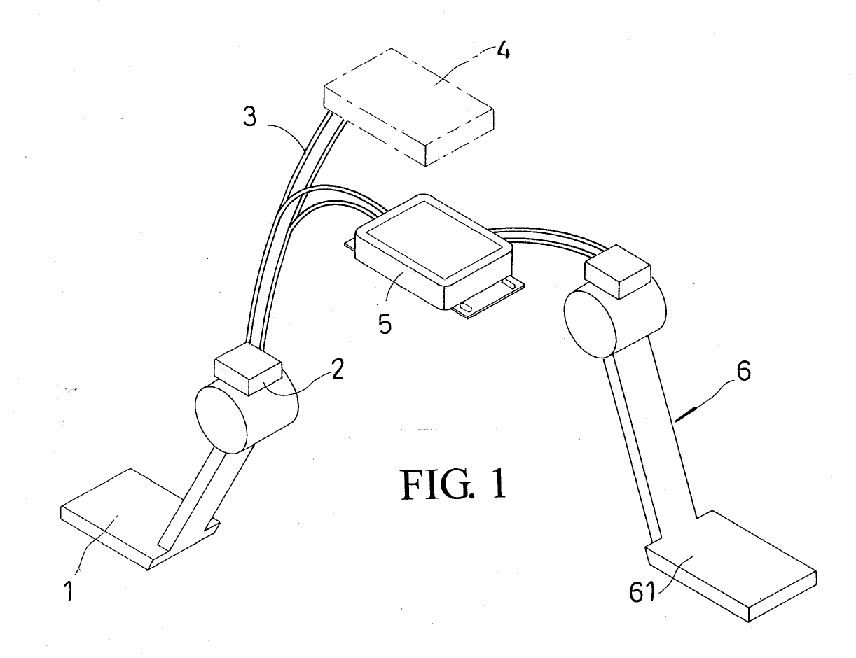

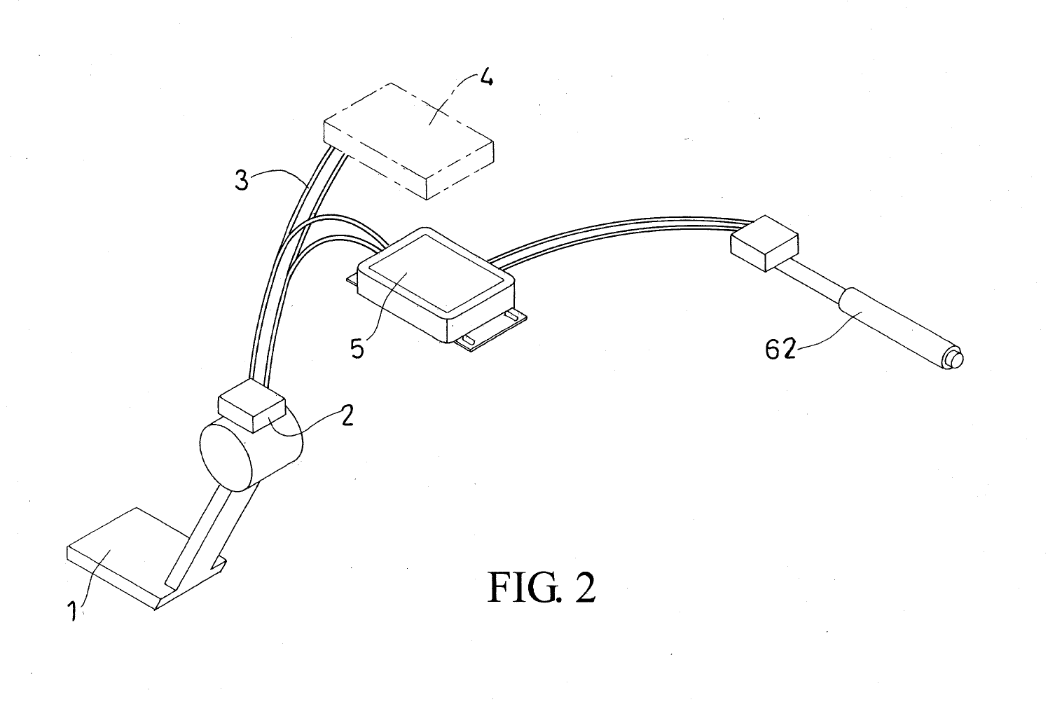

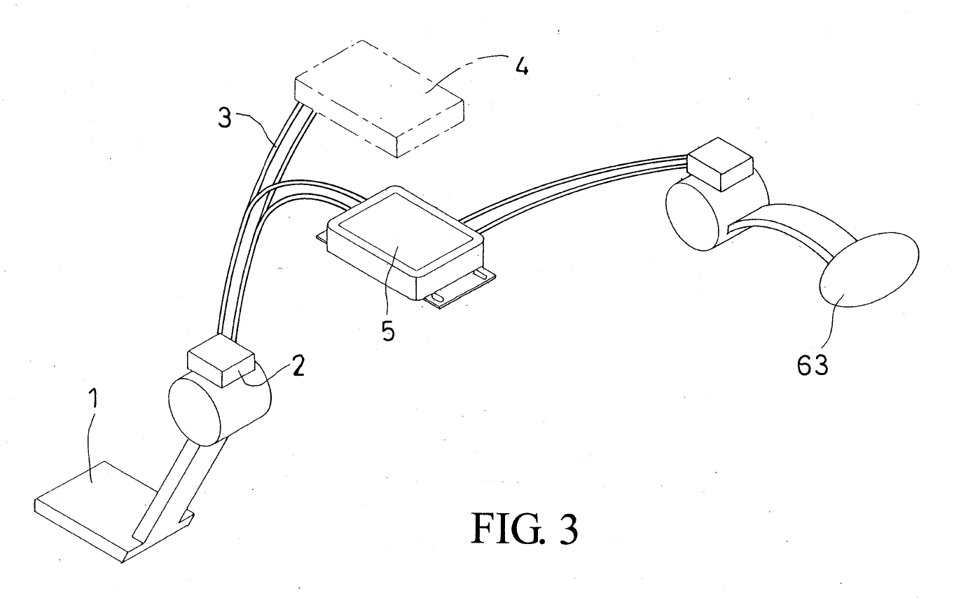

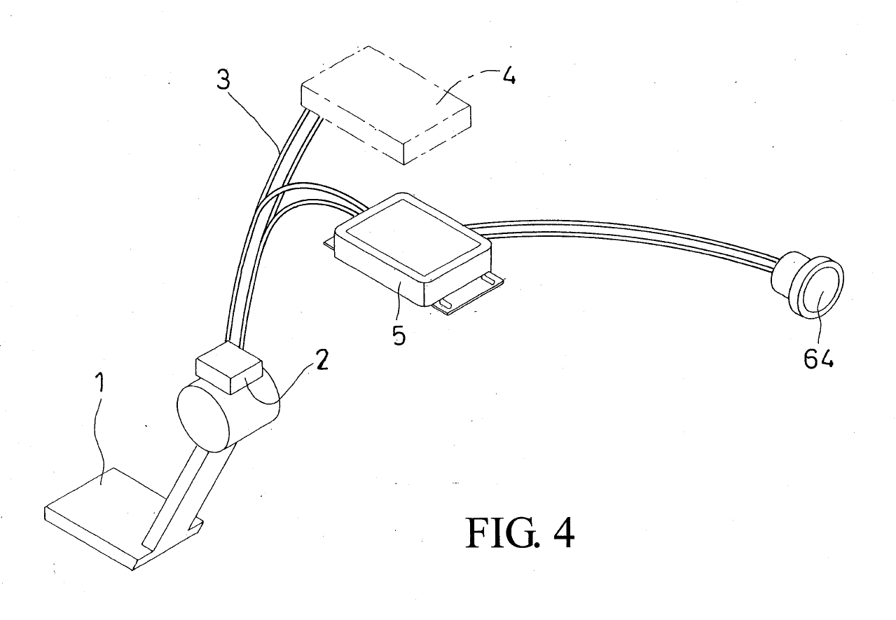

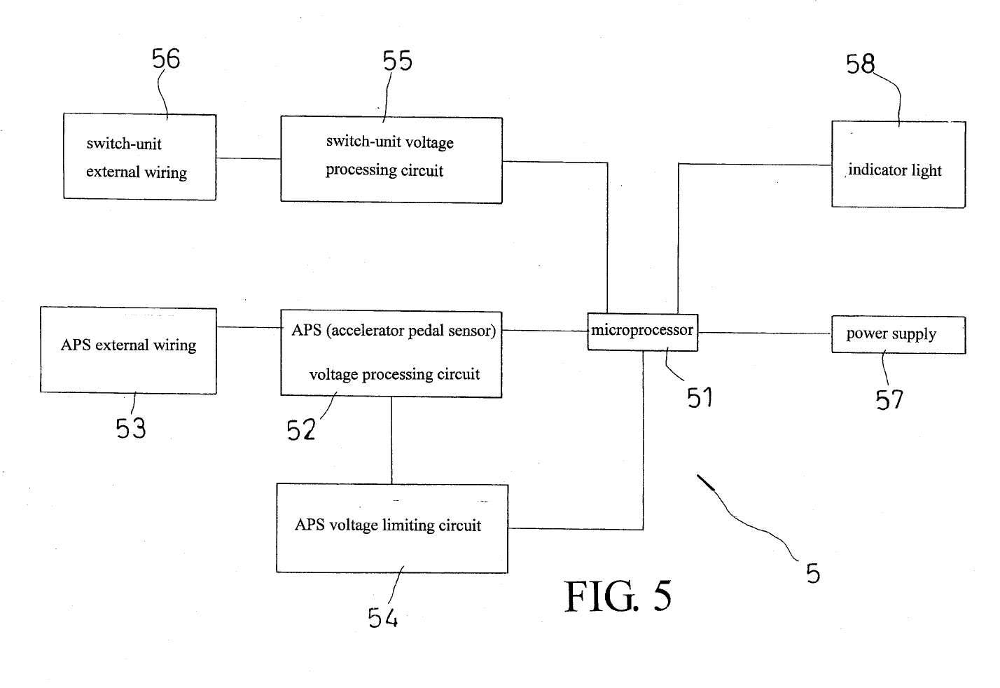

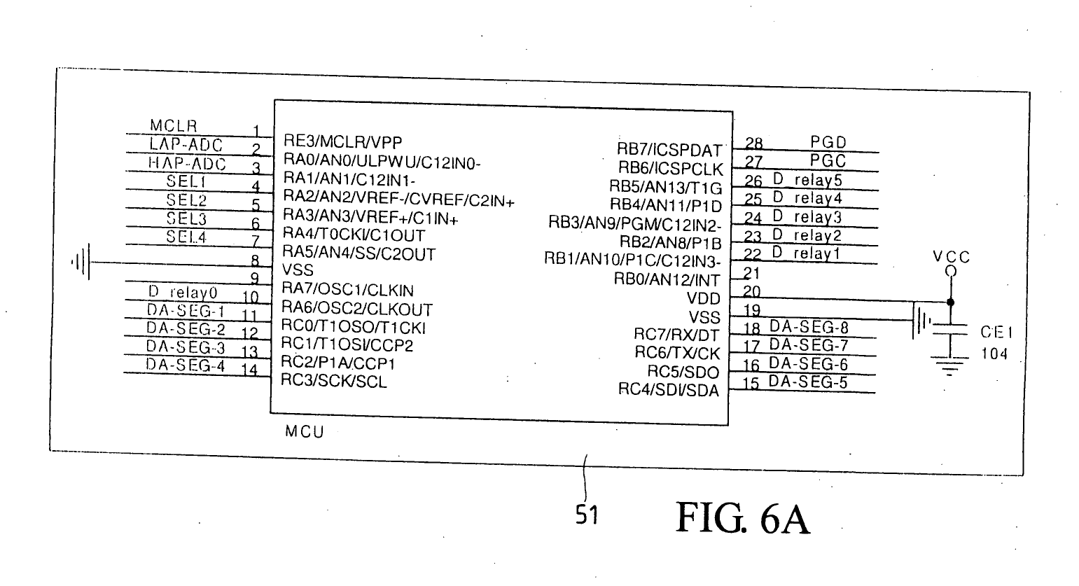

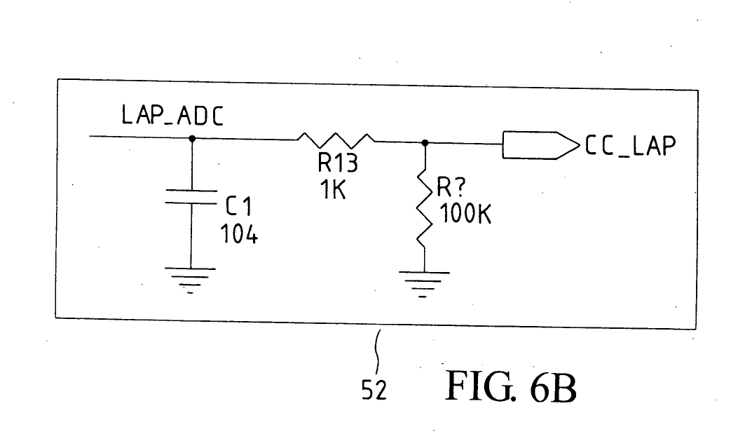

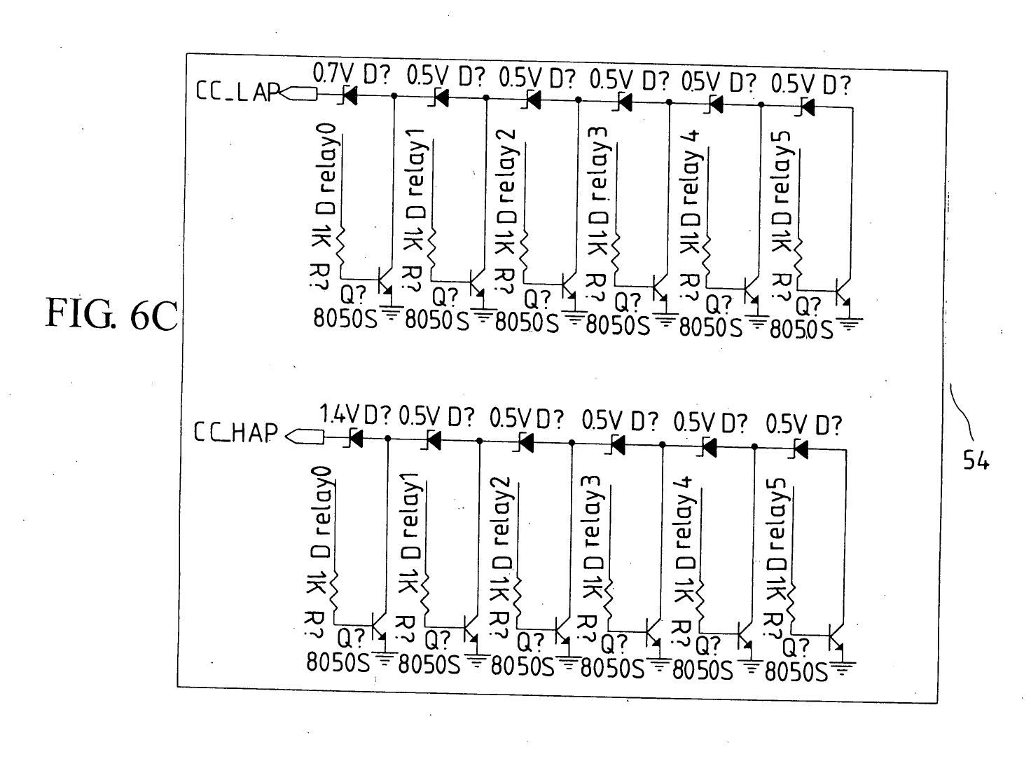

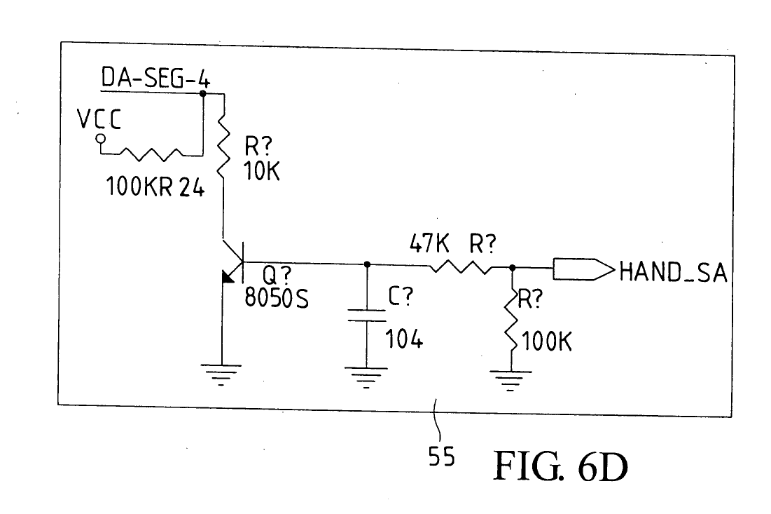

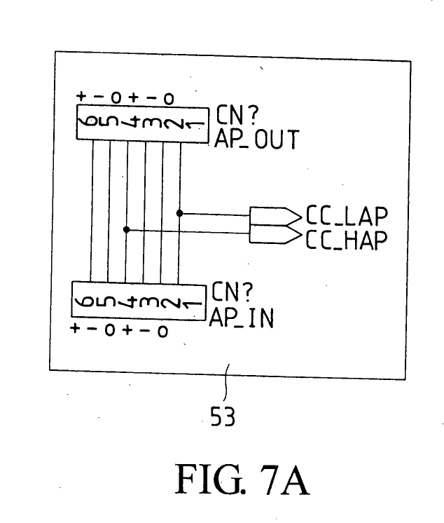

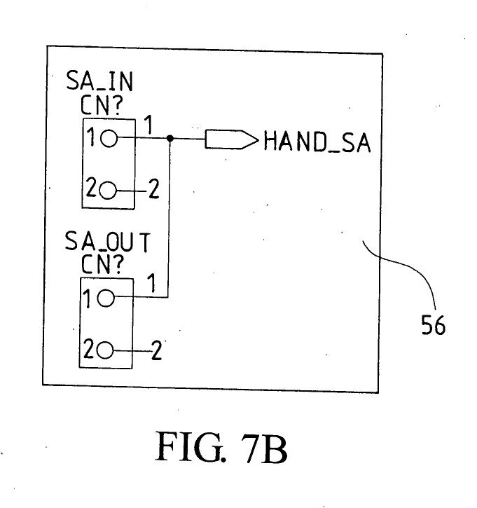

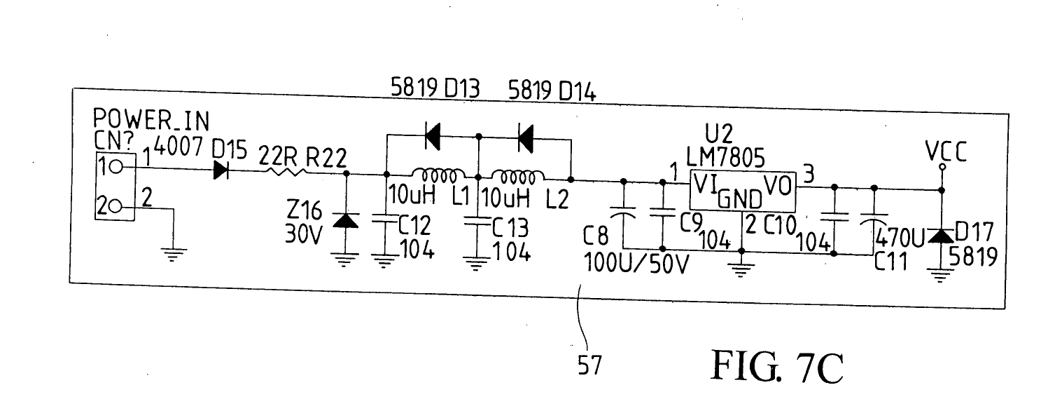

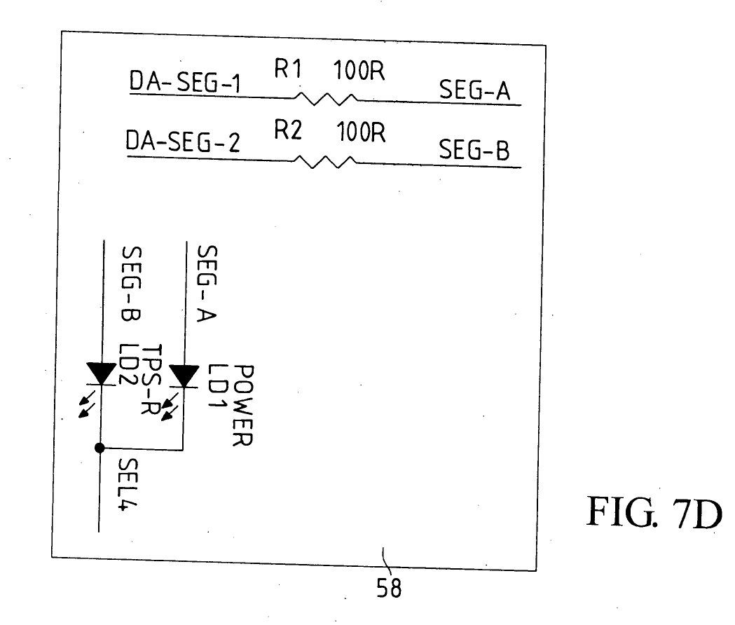

Refer to FIG. 1, a for preventing sudden acceleration of vehicles mainly includes a vehicle accelerator pedal 1 that is electrically connected with an accelerator pedal sensor (APS) 2, and two load feedback signal lines 3 of the APS 2 electrically connected with an electronic control unit (ECU) 4. Moreover, a voltage control unit 5 is electrically connected with the APS 2 and is connected with the two load feedback signal lines 3 of the APS 2 in parallel. Refer to FIG. 5, FIG. 6 and FIG. 7, the voltage control unit 5 mainly includes a microprocessor 51 that is electrically connected with an APS voltage processing circuit 52. The APS voltage processing circuit 52 is electrically connected with an APS external wiring 53 while the APS external wiring 53 is electrically connected with the APS 2. The voltage control unit 5 is further arranged with an APS voltage limiting circuit 54 that is electrically connected with both the microprocessor 51 and the APS voltage processing circuit 52. Moreover, the voltage control unit 5 further includes a switch-unit voltage processing circuit 55 that is electrically connected with the microprocessor 51 and is also electrically connected with a switch-unit external wiring 56. The switch-unit external wiring 56 is electrically connected with a switch unit 6. The switch unit 6 can be a foot brake 61, a hand brake 62 (as shown in FIG. 2), a pedal parking brake 63 (as shown in FIG. 3), or a button 64 (as shown in FIG. 4) set on a steering wheel or instrument panels. Furthermore, the microprocessor 51 and a power supply 57 are electrically connected while a power source and an active indicator light 58, outside the voltage control unit 5, are electrically connected with the microprocessor 51.

Back to FIG. 1, during the driving processes, when the two load feedback signal lines 3 of the vehicle APS 2 send abnormal signals to the ECU 4 during normal driving and cause increasing of engine speed that results in sudden acceleration of the vehicle, users can activate the switch unit 6 immediately. Also refer to FIG. 5, FIG. 6 and FIG. 7, a signal from the switch unit 6 is passing through the switch-unit external wiring 56, the switch-unit voltage processing circuit 55 and transmitted to the microprocessor 51. After receiving the signal, the microprocessor 51 drives the APS voltage limiting circuit 54 to send a voltage drop signal passing through the APS voltage processing circuit 52, the APS external wiring 53, to the APS 2. Then the APS 2 transmits the voltage drop signal to the two load feedback signal lines 3 so as to reduce the voltage of the two load feedback signal lines 3 to a lower level. Next the two load feedback signal lines 3 sends a signal after the voltage drop to the ECU 4 so as to make the ECU 4 slow the engine speed into idle speed. Thereby the sudden acceleration problem is fixed and injuries or damages caused by the unexpected acceleration are further avoided.

When the vehicle is parked and the user activates the switch unit 6 such as the foot brake 61, the hand brake 62 or the pedal parking brake 63 so as to stop and located the vehicle, the voltage control unit 5 is also turned on at the same time. Thus the voltage of the two load feedback signal lines 3 of the APS is reduced to a lower level by the voltage control unit 5 and the ECU 4 sets the engine to idle speed. Only when the user pulls the switch unit 6 such as the foot brake 61, the hand brake 62 or the pedal parking brake 63 back, the voltage drop and the idle speed are stopped and the vehicle runs normally. Thereby the unintended acceleration problem caused by mistakenly hitting the accelerator pedal 1 is avoided while the user parking the car.

In addition, the power source and the active indicator light 58 outside the voltage control unit 5 enable the user to know clearly that the voltage control unit 5 is turned on. When the sudden acceleration occurs, the user drives the voltage control unit 5 to work by the switch unit 6. By the active indicator light 58, the user do know the voltage control unit 5 has been turned on and worked well, sending the voltage drop signals to the two load feedback signal lines 3 of the APS 2. Thereby the user feels safe by the active indicator light 58 that shows the operation state of the present invention.

In summary, the present invention has following advantages:

1. The present invention includes the voltage control unit that is assembled with APS and ECU available on vehicles. Thus when the two load feedback signal lines of the APS are under abnormal operating conditions that cause sudden acceleration of vehicles, users can immediately operate the switch unit for driving the voltage control unit to reduce voltage of the two load feedback signal lines to a lower level. Thus the ECU reduces the engine speed into idle speed and sudden acceleration of vehicles is avoided instantly.
2. The present invention is arranged with a power source and an active indicator light, both outside the voltage control unit. Thus users can learn that the voltage control unit is on and working well by the external active indicator light and feel safe.
3. The switch unit for control of the voltage control unit can be a hand brake, a foot brake, or a button set on a steering wheel or instrument panels. Thus users can activate the switch unit on time so as to drive the voltage control unit working and sudden acceleration of vehicles is avoided immediately.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A device for preventing sudden acceleration of vehicles comprising an accelerator pedal sensor (APS) electrically connected with a vehicle accelerator pedal, two load feedback signal lines of the APS that are electrically connected with an electronic control unit (ECU) and a voltage control unit, wherein
the voltage control unit is electrically connected with the APS and is connected with the two load feedback signal lines of the APS in parallel for control of voltage of the two load feedback signal lines;
the voltage control unit is further electrically connected with a switch unit.

2. The device as claimed in claim 1, wherein the voltage control unit includes a microprocessor that is electrically connected with an APS voltage processing circuit, an APS voltage limiting circuit that is electrically connected with both the microprocessor and the APS voltage processing circuit, a switch-unit voltage processing circuit that is electrically connected with both the microprocessor and a switch-unit external wiring, and a power supply electrically connected with the microprocessor; the APS voltage processing circuit is electrically connected with an APS external wiring while the APS external wiring is electrically connected with the APS; the switch-unit external wiring is electrically connected with the switch unit.

3. The device as claimed in claim 2, wherein the voltage control unit is disposed with an indicator light that is electrically connected with the microprocessor.

4. The device as claimed in claim 3, wherein the switch unit is a hand brake.

5. The device as claimed in claim 3, wherein the switch unit is a pedal parking brake.

6. The device as claimed in claim 3, wherein the switch unit is a foot brake.

7. The device as claimed in claim 3, wherein the switch unit is a button.

8. The device as claimed in claim 1, wherein the voltage control unit is disposed with an indicator light.

9. The device as claimed in claim 1, wherein the switch unit is a hand brake.

10. The device as claimed in claim 1, wherein the switch unit is a pedal parking brake.

11. The device as claimed in claim 1, wherein the switch unit is a foot brake.

12. The device as claimed in claim 1, wherein the switch unit is a button.
